(19) United States
(12) Patent Application Publication
(10) Pub. No.: US 2003/0103631 A1
(43) Pub. Date: Jun. 5, 2003

(54) Medium-frequency stereo broadcast receiving circuit

(76) Inventors: Yasuhiro Ito, Tokyo (JP); Yasuaki Nishida, Tokyo (JP); Takashi Ando, Tokyo (JP); Kazuhiro Daikoku, Tokyo (JP); Shinichi Hosoya, Tokyo (JP)

Correspondence Address: John Russell Uren, P. Eng., 1337 Gulf Road, P.O. Box 1304, Point Roberts, WA, 98281-1304, US

(21) Appl. No.: 10/274,282

(22) Filed: Oct. 18, 2002

(30) Foreign Application Priority Data
Oct. 24, 2001 (JP) 2001-326586

(51) Int. Cl. H04H 5/00

(52) U.S. Cl. 381/2; 381/3; 381/10; 381/16

(57) ABSTRACT

The invention addresses itself to the task of providing a medium-frequency stereo broadcast receiving circuit that does not require any alteration of the radio wave format used in the medium-frequency stereo broadcast system that has become the de facto standard, and that receives transmitted broadcast waves and removes, in the course of the demodulation process, disturbance that has affected the signal during its propagation, thereby improving the audio quality of the demodulated signal and obtaining the full potential of the stereo effect. To achieve this, the received medium-frequency stereo broadcast wave is converted to a single-sideband signal, and the sum signal (L+R) is demodulated from the phase term of this converted single-sideband signal. The difference signal (L−R) is demodulated from the phase term of the received medium-frequency stereo broadcast wave and from the demodulated sum signal output.

### BACKGROUND OF THE INVENTION

1. Field of the Invention

The present invention relates to a receiving circuit for receiving medium-frequency stereo broadcasts. Compatible-Quadrature amplitude modulation (C-Quam), a system devised by the Motorola Corporation of the USA, has become the de facto standard for medium-frequency stereo broadcasting. The present invention relates to a technique for improving the audio quality of the demodulated signal while obtaining a full stereo effect in a medium-frequency stereo broadcast receiving circuit for receiving and demodulating a C-Quam broadcast wave.

2. Description of Related Art

Medium-frequency stereo broadcasting first began in the USA in 1982. It was implemented in Australia in 1985, in Brazil in 1986, in Canada in 1988, and in Japan in 1992. In the USA, four systems have been proposed in addition to C-Quam, but these other systems have been suppressed and at present C-Quam is the main system in use, with over 600 stations already using it for stereo broadcasts. Numerous other countries including Japan have adopted the C-Quam system as the standard system, and outside the USA a total of over 150 stations are now offering C-Quam based stereo broadcasts.

In order to maintain compatibility with conventional medium-frequency broadcast receivers, C-Quam forms a sum signal (L+R) and a difference signal, (L−R) from the left and right information signals, forms an angle-modulated wave that has been modulated by these sum and difference signals, and transmits a signal obtained by amplitude modulating this angle-modulated wave with the sum signal (L+R). Because the component that has been amplitude-modulated by the sum signal (L+R) can be received by a conventional monophonic medium-frequency receiver, compatibility is assured.

However, the following problems have been encountered with conventional C-Quam demodulation technology:

1. Because the C-Quam system uses quadrature detection with synchronous detection of the in-phase modulation component (the I-channel) and the quadrature-modulation component (the Q-channel), accurate tuning is required to demodulate the sum signal (L+R) and the difference signal (L−R).

2. In order to obtain a stereo signal using the C-Quam system, the difference signal (L−R) has to be demodulated from the quadrature-modulation component (the Q-channel) by means of synchronous detection, and this necessitates processing that accurately removes redundant modulation components contained in the received signal. However, because it is difficult to perform this processing accurately, the audio quality of the demodulated signal during stereo reception is poorer than the audio quality during reception of a monophonic broadcast.

3. A shortcoming of the conventional demodulation method employed in C-Quam is that because it utilizes the amplitude component of the broadcast wave, it is susceptible to external noise. In an actual receiver, this susceptibility is eliminated as much as possible by narrowing the pass band of the main band-limiting filter. However, this makes it difficult to obtain a high-fidelity demodulated signal from the transmitted information signal.

4. Because these problem are encountered with the C-Quam system, existing receivers do not display the stereo effect to its full potential and cannot secure truly excellent audio quality.

### SUMMARY OF THE INVENTION

It is an object of the present invention to provide a medium-frequency stereo broadcast receiving circuit that overcomes the above-mentioned problems; that does not alter the radio wave format used in the medium-frequency stereo broadcast system that has become the de facto standard; and that receives transmitted broadcast waves and removes, in the course of the demodulation process, disturbance that has affected the signal during its propagation, thereby improving the audio quality of the demodulated signal and obtaining the full potential of the stereo effect.

The medium-frequency stereo broadcast receiving circuit of this invention receives and demodulates a medium-frequency stereo broadcast wave—and in particular, a C-Quam broadcast wave—comprising an angle-modulated wave that has been modulated by the sum signal (L+R) and by the difference signal (L−R) of the left and right information signals, and which has also been amplitude-modulated by the sum signal. This medium-frequency stereo broadcast receiving circuit comprises: sum signal demodulation means for converting the received medium-frequency stereo broadcast wave to a single-sideband signal containing a carrier, and for demodulating the sum signal from the phase term of this converted single-sideband signal; and difference signal demodulation means for demodulating the difference signal from the phase term of the received medium-frequency stereo broadcast wave and the demodulated output of the sum signal demodulation means.

The present invention introduces the inventive step of demodulating both the sum and the difference signals from the phase term of the C-Quam modulated signal. The reason for doing this is that the information signal component present in the phase term of the modulated signal is not readily susceptible to the effect of multiplicative or additive external noise, and as a result exhibits excellent transmission quality. The superior reception characteristics of an FM broadcast wave compared with an AM broadcast wave are likewise due to the fact that the information signal component in a frequency modulated signal is present only in the phase term and is demodulated from this phase term.

We have therefore employed a demodulation processing method which removes the modulation component contained in the phase term of the amplitude-modulated signal, converts this modulation component to an RZ SSB signal, and then demodulates the sum signal (L+R) from the phase term of this RZ SSB signal. A demodulation processing technique of this sort is known as Real Zero Single Sideband (RZ SSB) modulation and demodulation, and is capable of removing, during the demodulation process, amplitude distortion due to external noise. Details of RZ SSB modulation and demodulation are given in JP H06-018333 B (granted as Japanese Patent No. 1888866).

To remove the modulation component contained in the phase term of the amplitude-modulated signal, the sum signal demodulation means preferably comprises: first frequency conversion means for frequency converting the received medium-frequency stereo broadcast wave; means for branching the input signal to this first frequency conversion means and for limiting the amplitude of the branched portion of the signal; and second frequency conversion means for performing frequency conversion by multiplying together the output of this amplitude limiting means and the output of the first frequency conversion means.

The signal that is required in order to extract the sum signal—i.e., a pure amplitude-modulated wave from which the modulation component due to the difference signal has been removed and which comprises only the signal component due to modulation by the sum signal—is obtained at the output of the second frequency conversion means. By converting this to a single-sideband signal, the sum signal can be extracted from the phase term of this signal, without concern that there are some extra signal components that have been overlooked. Moreover, the output of the second frequency conversion means is free of the influence of fading and frequency fluctuation.

The second frequency conversion means and subsequent means are preferably provided in the intermediate frequency stage. This ensures that a high-quality demodulated signal is obtained irrespective of the frequency stability of the local oscillator in the high-frequency stage. As a result, the present invention does not forfeit the important feature of conventional envelope demodulation, namely, that demodulation characteristics are independent of frequency fluctuation. At the same time, it can accurately maintain the frequency characteristics of the transmitted information signal.

The invention is also cleverly contrived so that the difference signal (L−R) as well can be demodulated from the phase term of the received signal. The method employed will be described below.

A C-Quam medium-frequency stereo broadcast wave can be expressed as a function of time (t) by:

S(t)=(1+L+R) cos (ω_{c}t+Φ(t))

where

tan Φ(t)=(L−R+P)/(1+L+R)

and ω_{c} is the angular frequency of the carrier, (L+R) is the sum signal, (L−R) is the difference signal, and P is a pilot signal superimposed on the difference signal. Preferably, the difference signal demodulation means for demodulating the difference signal from a modulated signal of this sort comprises: a frequency discriminator for discriminating the frequency of the received medium-frequency stereo broadcast wave and extracting the angle component d/dt(Φ(t)); an integrator for integrating the extracted angle component d/dt(Φ(t)); a tangent function generator for generating the tangent function value tan Φ(t) of the output Φ(t) of this integrator; and means for multiplying together the output of this tangent function generator and the signal obtained by equalizing the delay of the output of the sum signal demodulation means and adding a suitable constant.

An amplitude limiter (a hard limiter) is provided at the input to the difference signal demodulation means, but if amplitude limiting means is provided in the sum signal demodulation means, it would be possible to share this amplitude-limiting means by using it also as the amplitude limiter at the input to the difference signal demodulation means.

Because an amplitude-modulated wave comprises an upper sideband and a lower sideband, the sum signal demodulation means preferably comprises frequency diversity means which, when converting the signal that has been amplitude-modulated by the sum signal (L+R) into a single-sideband signal, superimposes the received medium-frequency stereo broadcast wave and the signal obtained by reversing, in the frequency domain, the distribution of frequency components of this wave, and converts the resulting superimposed signal into one single-sideband signal.

The frequency diversity means is provided in an intermediate frequency stage and can comprise: first frequency conversion means for multiplying together the medium-frequency stereo broadcast wave that has been converted to an intermediate frequency, and a local oscillator signal with a higher frequency than this carrier component, and for extracting the difference frequency component and the sum frequency component, which have mutually reversed distributions, in the frequency domain, of signal frequency components; means for branching the input signal to this first frequency conversion means and for limiting the amplitude of the branched portion of the signal; second frequency conversion means for (i) multiplying together the output of this amplitude limiting means and the difference frequency component extracted by the first frequency conversion means, and for extracting the sum frequency component, and for (ii) multiplying together the output of the amplitude limiting means and the sum frequency component extracted by the first frequency conversion means, and for extracting the difference frequency component; and means for adding the sum frequency component and the difference frequency component obtained by the second frequency conversion means.

The medium-frequency stereo broadcast receiving circuit of this invention is preferably implemented using digital signal processing (DSP) technology, so that high-performance processing of the received signal can be carried out by an inexpensive circuit. Use of such technology renders circuit adjustment unnecessary and means that DSP processors can be used, which can be expected to offer volume production benefits. As a result, an economic receiver is assured.

### BRIEF DESCRIPTION OF THE DRAWINGS

Specific embodiments of the present invention will now be described, by way of example only, with reference to the accompanying of drawings in which:

FIG. 1 is a block diagram of a medium-frequency stereo broadcast receiving circuit according to a first embodiment of the present invention;

FIG. 2 is a block diagram of a medium-frequency stereo broadcast receiving circuit according to a second embodiment of the invention; and

FIG. 3 is a block diagram of a medium-frequency stereo broadcast receiving circuit according to a third embodiment of the invention.

### DETAILED DESCRIPTION OF THE PREFERRED EMBODIMENTS

To aid an understanding of this invention, we give a brief description of a C-Quam transmitted wave. A wave transmitted after modulation according to the C-Quam scheme can be written as:

S(t)=(1+L+R) cos (ω_{c}t+Φ(t)) (1)

where

tan Φ(t)=(L−R+P)/(1+L+R) (2)

and ω_{c} is the angular frequency of the carrier, (L+R) is the sum signal, (L−R) is the difference signal, and P is a pilot signal superimposed on the difference signal. To ensure that the amplitude-modulated component is not overmodulated, it is essential that:

|L+R|<1 (3)

The following embodiments are described in terms of the use of a transmitted wave that can be expressed by Equation 1.

First Embodiment

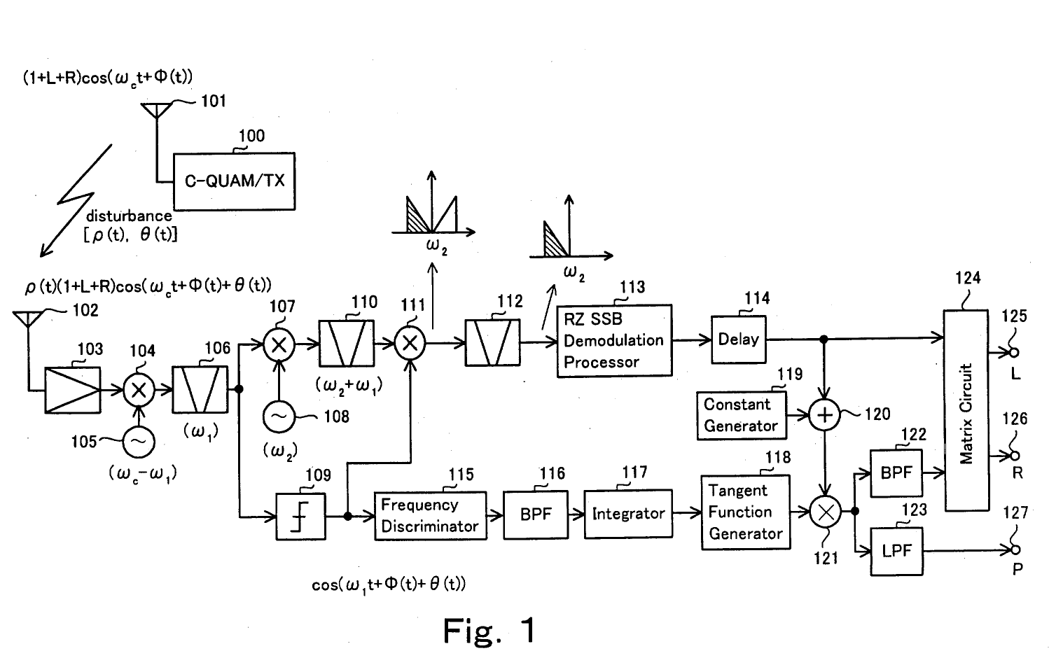

A first specific embodiment of the present invention will now be described. FIG. 1 is a block diagram showing the configuration of this first embodiment, which comprises C-Quam transmitter 100, transmitting antenna 101, receiving antenna 102 of a C-Quam receiver, front-end amplifier 103, frequency converter 104, local oscillator 105, intermediate frequency (IF) filter 106, frequency converter 107, local oscillator 108, amplitude limiter (hard limiter) 109, IF filter 110, frequency converter 111, IF filter 112, RZ SSB demodulation processor 113, delay circuit 114, frequency discriminator 115, band-pass filter 116, integrator 117, tangent function generator 118, constant generator 119, adder 120, multiplier 121, band-pass filter 122, low-pass filter 123, matrix circuit 124, left audio signal output terminal 125, right audio signal output terminal 126, and pilot signal output terminal 127.

A brief description will now be given of signal flow in this first embodiment shown in FIG. 1, and of the functioning of its component circuits.

The output of C-Quam transmitter 100 is transmitted as a C-Quam modulated wave by transmitting antenna 101.

The C-Quam modulated wave is received by antenna 102 of the C-Quam receiver, and after it has been amplified by front-end amplifier 103, is converted by frequency converter 104 to an IF signal—for example, to the difference frequency between the received signal and the signal from local oscillator 105. The required IF signal is then extracted by IF filter 106.

This extracted signal is split into two portions and one portion supplied to frequency converter 107 where the output of local oscillator 108 is used to convert it to the sum frequency signal. The required IF signal is then extracted by IF filter 110. The other split portion of the signal is supplied to amplitude limiter (hard limiter) 109 where it is converted to a fixed-amplitude signal. The output of amplitude limiter (hard limiter) 109 is split into two portions and one portion supplied to frequency converter 111, which functions so as to form the difference frequency signal between the output of frequency limiter 109 and the output of IF filter 110. IF filter 112 extracts the lower sideband component of this difference frequency signal, this lower sideband component having had some unwanted noise components removed and being accompanied by a carrier component. The output of IF filter 112 is supplied to RZ SSB demodulation processor 113 which demodulates it, thereby obtaining the sum signal (L+R). This sum signal is supplied to delay circuit 114.

The other split portion of the output of amplitude limiter (hard limiter) 109 has its angle component extracted by frequency discriminator 115. The output of frequency discriminator 115 has its DC component and random FM noise component removed by band-pass filter 116. The output of band-pass filter 116 is integrated by integrator 117, after which tangent function generator 118 generates the tangent value corresponding to the input angle.

The output of delay circuit 114 is split into two portions, one of which is added by adder 120 to the output of constant generator 119. The output of adder 120 is multiplied, by multiplier 121, by the output of tangent function generator 118. The output of multiplier 121 is split into two portions, one of which is supplied to band-pass filter 122 and the other to low-pass filter 123. Band-pass filter 122 provides a signal from which unwanted noise components have been removed. This signal is supplied to matrix circuit 124. The other split portion of the output of delay circuit 114 is also supplied to matrix circuit 124, whereupon the left signal is output from left audio signal output terminal 125 and the right signal is output from right audio signal output terminal 126. The pilot signal P is obtained from the output of low-pass filter 123, and is output from pilot signal output terminal 127.

The operation of the component circuits will now be described using mathematical expressions. During its propagation, the signal radiated from transmitting antenna 101 is subject to random amplitude fluctuation and to phase fluctuation (termed“random FM noise”), which obey the Rayleigh distribution rule and can be represented respectively by ρ(t) and θ(t) in the amplitude and phase terms. These amplitude and phase fluctuations affect the signal as multiplicative disturbances. Hence the signal that arrives at C-Quam receiver antenna 102 is given by:

Srl(t)=ρ(t)(1+L+R) cos (ω_{c}t+Φ(t)+θ(t)) (4)

The received signal is amplified by front-end amplifier 103 (which preferably changes its degree of amplification by means of a Received Signal Strength Indication mechanism). Then, by way of example, frequency converter 104 uses the signal from local oscillator 105, which has a center angular frequency of ω_{c}−ω₁ and an angular frequency fluctuation of ±δω, to convert the received signal to the difference frequency, whereby it is converted to an IF signal with a center angular frequency of al. IF filter 106 extracts just the required IF signal component. If thermal noise added by front-end amplifier 103 is ignored, the extracted signal is easily derived from Equation 4:

S1a(t)=ρ(t)(1+L+R) cos ((ω₁±δω)t+Φ(t)+θ(t)) (5)

which can be rewritten as:

$$S1a ( t ) = ρ ( t ) [ cos Θ ( t ) + \{ ( {L}_{+} + {R}_{+} ) cos ( Θ ( t ) ) - H ( ( {L}_{+} + {R}_{+} ) ) sin ( Θ ( t ) ) \} / 2 + \{ ( {L}_{-} + {R}_{-} ) cos ( Θ ( t ) ) + H ( ( {L}_{-} + {R}_{-} ) ) sin ( Θ ( t ) ) \} / 2 ] \qquad ( 6 )$$

where:

Θ(t)=(ω₁±δω)t+Φ(t)+θ(t)

(L₊+R₊)=(L₋+R₋)

H((L₊+R₊))=H((L₋+R₋))

and (L₊+R₊) and (L₋+R₋) represent, respectively, the information signal present in the upper sideband region and the lower sideband region of the transmitted wave, and H((L₊+R₊)) represents the Hilbert transformation of (L₊+R₊). The first, second and third terms in Equation 6 are the mathematical representations of the carrier component, the upper sideband component, and the lower sideband component, respectively. At this stage in the signal processing, the mutual arrangement of the upper and lower sideband components is the same as in the transmitted wave. From Equation 6 it will be seen that in an AM signal that is not overmodulated—i.e., in an AM signal that satisfies the condition expressed by Equation 3—the carrier component is always 6 dB higher than the sideband components. In FIG. 1, the signals are depicted in such manner that the upper sideband component and the lower sideband component can be distinguished. Although Equation 5 and Equation 6 are mathematically equivalent, when we are considering single sideband components we will use Equation 6 whenever it is necessary to discuss extracting a specific single sideband component, i.e., specifically either the upper sideband component or the lower sideband component.

In this embodiment, we consider ordinary frequency conversion in a conventional AM receiver i.e., in an AM receiver for medium-frequency or high-frequency AM broadcasts) which includes a C-Quam receiver. Because a medium-frequency or high-frequency carrier is by its nature of relatively low frequency, it is often converted to an intermediate frequency ω_{IF1} using, as local oscillator frequency ω_{L1}, a frequency that is higher than the carrier frequency ω_{c}. The purpose of this is to prevent admixture of spurious (unwanted) signals into the IF frequency region. If the sidebands of the received signal are observed when this is done, the upper and lower sidebands are seen to be reversed. If IF frequency ω_{IF1}, thus obtained is converted to a lower IF frequency cain and if this second frequency conversion is likewise performed using a frequency that is higher than IF frequency ω_{IF1}, the sidebands are again reversed and are thereby restored to their original arrangement. Although it is assumed that in practice this double conversion will be performed, in the present embodiment, for the sake of simplicity we have described a single-stage frequency conversion of the sort outlined in the preceding paragraphs, but this has no impact on the essence of the present invention. The same simplified version of frequency conversion is described in second and third embodiments of the invention below.

The signal expressed by Equation 5 or Equation 6 is split into two portions. One portion of the split signal is supplied to frequency converter 107, which uses local oscillator 108 with angular frequency ω₂ to form the sum frequency, thereby converting the signal from IF filter 106 to an IF signal with a center angular frequency of ω₁+ω₂. IF filter 110 then extracts only this required IF signal component. Using the representation given in Equation 6, this extracted signal can be given as:

$$S1b ( t ) = ρ ( t ) [ cos ( Θ ( t ) + {ω}_{2} t ) + \{ ( {L}_{+} + {R}_{+} ) cos ( Θ ( t ) + {ω}_{2} t ) - H ( ( {L}_{+} + {R}_{+} ) ) sin ( Θ ( t ) + {ω}_{2} t ) \} / 2 + \{ ( {L}_{-} + {R}_{-} ) cos ( Θ ( t ) + {ω}_{2} t ) + H ( ( {L}_{-} + {R}_{-} ) ) sin ( Θ ( t ) + {ω}_{2} t ) \} / 2 ] \qquad ( 7 )$$

The other portion of the split signal is supplied to amplitude limiter (hard limiter) 109 where it is converted to a fixed-amplitude signal. Using the representation given in Equation 5, this is:

$$S1 lim = cos ( ( {ω}_{1} \pm δω ) t + Φ ( t ) + θ ( t ) ) = cos ( Θ ( t ) ) \qquad ( 8 )$$

whereby it will be seen that the random amplitude fluctuation component ρ(t) has been removed. When the signals represented by Equation 7, i.e., the output of IF filter 110, and by Equation 8, i.e., the output of amplitude limiter (hard limiter) 109, are input to frequency converter 111 and their difference frequency component extracted, the signal obtained is:

$$\begin{matrix}S1c ( t ) = ρ ( t ) [ cos ( {ω}_{2} t ) + \{ ( {L}_{+} + {R}_{+} ) cos ( {ω}_{2} t ) - H ( ( {L}_{+} + {R}_{+} ) ) sin ( {ω}_{2} t ) \} / 2 + \{ ( {L}_{-} + {R}_{-} ) cos ( {ω}_{2} t ) + H ( ( {L}_{-} + {R}_{-} ) ) sin ( {ω}_{2} t ) \} / 2 ] & ( 9 ) \\ = ρ ( t ) ( 1 + L + R ) cos ( {ω}_{2} t ) & ( 10 )\end{matrix}$$

In other words, the frequency fluctuation ±δω of local oscillator 105, the modulation component Φ(t), and the random disturbance component θ(t) that are contained in the phase term can be completely removed. At the same time, the angular frequency of the carrier is converted to ω₂. Consequently, frequency stability in the subsequent demodulation processing is dependent only on local oscillator 108. As a result, if angular frequency ω₂ is low, frequency stability ceases to be a practical problem and a sharp filter can be used in the subsequent signal processing.

Next, the use of IF filter 112 serves to extract, from the signal expressed by Equation 9, only the lower sideband signal, this being a signal from which some unwanted noise components have been removed and to which a carrier component has been added. Omitting remaining noise components from the mathematical expression, this extracted signal can be represented by:

S1d(t)=ρ(t){(1+(L₋+R₋)/2) cos (ω₂t)+(H((L₋+R₋)/2)) sin (ω₂t)} (11)

which indicates that the lower sideband signal of the transmitted wave is extracted. Because this extracted lower sideband signal has a carrier component which, as mentioned previously, is 6 dB higher than the maximum value of the information signal, it can be used as ail RZ SSB signal. The use of RZ SSB demodulation processor 113 enables the random amplitude component ρ(t) to be removed and thereby provides a high-quality demodulated sum information signal (L+R).

When the angle component is extracted by frequency discriminator 115 from the other split portion of the output of amplitude limiter (hard limiter) 109, the resulting signal is:

$$\begin{matrix}S1e ( t ) = ⅆ / ⅆ t ( Θ ( t ) ) \\ = ( {ω}_{1} \pm δω ) + ⅆ / ⅆ t ( Φ ( t ) + θ ( t ) )\end{matrix} \qquad ( 12 )$$

When the DC component and the random FM noise component contained in this signal are removed by band-pass filter 116, the resulting signal is:

S1f(t)=d/dt(Φ(t)) (13)

When this output of band-pass filter 116 is integrated by integrator 117, the signal obtained is given by:

S1g(t)=Φ(t) (14)

thereby providing an angle signal Φ(t) which contains the modulation component relating to the sum and difference signals. Tangent function generator 118 operates on this angle signal to form:

S1h(t)=tan Φ(t) (15)

Delay circuit 114 is inserted to ensure that the processing delay up to and including RZ SSB demodulation processor 113 matches the processing delay from frequency discriminator 115 up to and including tangent function generator 118. The output of delay circuit 114 is added by adder 120 to the output of constant generator 119, whereby the following signal is obtained:

S1i(t)=1+L+R (16)

When the output of adder 120, expressed by Equation 16, is multiplied in multiplier 121 by the output of tangent function generator 118, expressed by Equation 15, the difference signal (L−R+P) is obtained:

$$\begin{matrix}S1j ( t ) = ( 1 + L + R ) tan Φ ( t ) \\ = L - R + P\end{matrix} \qquad ( 17 )$$

The relation shown in Equation 2 is used to derive this. The output of multiplier 121 is split into two portions, one of which is supplied to band-pass filter 122 and the other to low-pass filter 123. The difference signal (L−R) from which unwanted noise components have been removed by band-pass filter 122, and the sum signal (L+R) obtained from delay circuit 114, are supplied to matrix circuit 124, whereupon the left signal is output from left audio signal output terminal 125 and the right signal is output from right audio signal output terminal 126. The pilot signal P is obtained from the output of low-pass filter 123, and is output from pilot signal output terminal 127.

The signal processing after IF filter 106 can be performed by a DSP circuit. As explained above, when the lower sideband signal with added carrier component is extracted, frequency stability is determined solely by local oscillator 108, 7508 and therefore this extraction can be performed using IF filter 112 having sharp cut-off characteristics. Other advantages of a filter implemented by a DSP circuit include the fact that temperature characteristics, etc., do not have to be taken into consideration. If the embodiment shown in FIG. 1 is implemented using a DSP device, in order to make the frequency region in which unnecessary processing is performed as small as possible and so reduce the DSP power consumption, it is necessary to lower the sampling frequency of the RZ SSB demodulation processor. This can be achieved by shifting the signal frequency region to as low a frequency region as possible.

Second Embodiment

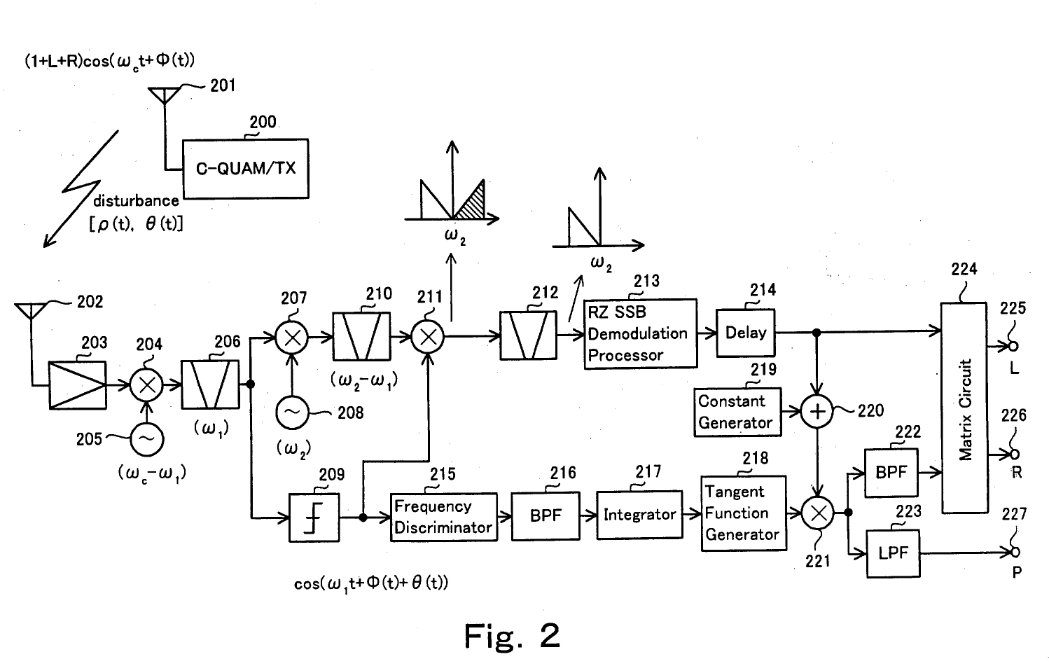

A second specific embodiment of the present invention will now be described. FIG. 2 is a block diagram showing the configuration of this second embodiment, which comprises C-Quam transmitter 200, transmitting antenna 201, receiving antenna 202 of a C-Quam receiver, front-end amplifier 203, frequency converter 204, local oscillator 205, IF filter 206, frequency converter 207, local oscillator 208, amplitude limiter (hard limiter) 209, IF filter 210, frequency converter 211, IF filter 212, RZ SSB demodulation processor 213, delay circuit 214, frequency discriminator 215, band-pass filter 216, integrator 217, tangent function generator 218, constant generator 219, adder 220, multiplier 221, band-pass filter 222, low-pass filter 223, matrix circuit 224, left audio signal output terminal 225, right audio signal output terminal 226, and pilot signal output terminal 227.

A brief description will now be given of signal flow in this second embodiment shown in FIG. 2, and of the functioning of its component circuits.

The output of C-Quam transmitter 200 is transmitted as a C-Quam modulated wave by transmitting antenna 201.

The C-Quam modulated wave is received by antenna 202 of the C-Quam receiver, and after it has been amplified by front-end amplifier 203, is converted by frequency converter 204 and local oscillator 205 to the difference frequency signal, whereupon the required IF signal is extracted by IF filter 206.

The extracted signal is split into two portions and one portion supplied to frequency converter 207. The difference frequency between this signal and the signal from local oscillator 208 is extracted by IF filter 210. The other split portion of the signal is supplied to amplitude limiter (hard limiter) 209 where it is converted to a fixed-amplitude signal. The output of amplitude limiter (hard limiter) 209 is split into two portions and one portion supplied to frequency converter 211, which functions so as to form the sum frequency component from the output of frequency limiter 209 and the output of IF filter 210. IF filter 212 extracts the lower sideband component from the output signal of frequency converter 211, this lower sideband component having had some unwanted noise components removed and being accompanied by a carrier component. The output of IF filter 212 is supplied to RZ SSB demodulation processor 213 which demodulates it, thereby obtaining the sum signal (L+R). This sum signal is supplied to delay circuit 214.

The other split portion of the output of amplitude limiter (hard limiter) 209 has its angle component extracted by frequency discriminator 215. The output of frequency discriminator 215 has its DC component and random FM noise component removed by band-pass filter 216. The output of band-pass filter 216 is integrated by integrator 217, after which tangent function generator 218 generates the tangent value corresponding to the input angle.

The output of delay circuit 214 is split into two portions, one of which is added by adder 220 to the output of constant generator 219. The output of adder 220 is multiplied, by multiplier 221, by the output of tangent function generator 218. The output of multiplier 221 is split into two portions, one of which is supplied to band-pass filter 222 and the other to low-pass filter 223. Band-pass filter 222 provides a signal from which unwanted noise components have been removed. This signal is supplied to matrix circuit 224. The other split portion of the output of delay circuit 214 is also supplied to matrix circuit 224, whereupon the left signal is output from left audio signal output terminal 225 and the right signal is output from right audio signal output terminal 226. The pilot signal P is obtained from the output of low-pass filter 223, and is output from pilot signal output terminal 227.

The operation of the component circuits will now be described using mathematical expressions. During its propagation, the signal radiated from transmitting antenna 201 is subject to random amplitude fluctuation and to phase fluctuation (random FM noise) which obey the Rayleigh distribution rule and can be represented respectively by ρ(t) and θ(t) in the amplitude and phase terms. These amplitude and phase fluctuations affect the signal as multiplicative disturbances. Hence the signal that arrives at C-Quam receiver antenna 202 is given by:

Sr2(t)=ρ(t)(1+L+R) cos (ω_{c}t+Φ(t)+θ(t)) (18)

The received signal is amplified by front-end amplifier 203 (which preferably changes its degree of amplification by means of a Received Signal Strength Indication mechanism). Then, by way of example, frequency converter 204 uses the signal from local oscillator 205, which has a center angular frequency of ω_{c}−ω₁ and an angular frequency fluctuation of ±δω, to convert the received signal to the difference frequency, whereby it is converted to an IF signal with a center angular frequency of ω₁. IF filter 206 extracts just the required IF signal component. If thermal noise added by front-end amplifier 203 is ignored, the extracted signal is easily derived from Equation 18:

S2a(t)=ρ(t)(1+L+R) cos ((ω₁±δ)t+Φ(t)+θ(t)) (19)

which can be rewritten as:

$$S2a ( t ) = ρ ( t ) [ cos Θ ( t ) + \{ ( {L}_{+} + {R}_{+} ) cos ( Θ ( t ) ) - H ( ( {L}_{+} + {R}_{+} ) ) sin ( Θ ( t ) ) \} / 2 + \{ ( {L}_{-} + {R}_{-} ) cos ( Θ ( t ) ) + H ( ( {L}_{-} + {R}_{-} ) ) sin ( Θ ( t ) ) \} / 2 ] \qquad ( 20 )$$

where:

Θ(t)=(ω₁±δω)t+Φ(t)+θ(t)

(L₊+R₊)=(L₋+R₋)

H((L₊+R₊))=H((L₋+R₋))

and (L₊+R₊) and (L₋+R₋) represent, respectively, the information signal present in the upper sideband region and the lower sideband region of the transmitted wave, and H((L₊+R₊)) represents the Hilbert transformation of (L₊+R₊). The first, second and third terms in Equation 20 are the mathematical representations of the carrier component, the upper sideband component, and the lower sideband component, respectively. At this stage min the signal processing, the mutual arrangement of the upper and lower sideband components is the same as in the transmitted wave. From Equation 20 it will be seen that in an AM signal that is not overmodulated—i.e., in an AM signal that satisfies the condition expressed by Equation 3—the carrier component is always 6 dB higher than the sideband components. In FIG. 2, the signals are depicted in such manner that the upper sideband component and the lower sideband component can be distinguished. Although Equation 19 and Equation 20 are mathematically equivalent, when we are considering single sideband components we will use Equation 20 whenever it is necessary to discuss extracting a specific single sideband component, i.e., specifically either the upper sideband component or the lower sideband component.

The signal expressed by Equation 19 or Equation 20 is split into two portions. One portion of the split signal is supplied to frequency converter 207, which uses local oscillator 208 with angular frequency ω₂ to form the difference frequency, thereby converting the signal from IF filter 206 to an IF signal with a center angular frequency of ω₂−ω₁. IF filter 210 then extracts only this required IF signal component. This extracted signal can be given as:

$$\begin{matrix}S2b ( t ) = ρ ( t ) ( 1 + L + R ) cos ( {ω}_{2} t - Θ ( t ) ) \\ = ρ ( t ) [ cos ( {ω}_{2} t - Θ ( t ) ) + \{ ( {L}_{+} + {R}_{+} ) cos ( {ω}_{2} t - Θ ( t ) ) + \\ H ( ( {L}_{+} + {R}_{+} ) ) sin ( {ω}_{2} t - Θ ( t ) ) \} / 2 + \{ ( {L}_{-} + {R}_{-} ) \\ cos ( {ω}_{2} t - Θ ( t ) ) - H ( ( {L}_{-} + {R}_{-} ) ) sin ( {ω}_{2} t - Θ ( t ) ) \} / 2 ]\end{matrix} \qquad ( 21 )$$

In this embodiment, the frequency relation ω₂>ω₁ is used. It will be seen that the positions of the top and bottom sideband components of the transmitted wave are reversed.

The other portion of the split signal is supplied to amplitude limiter (hard limiter) 209 where it is converted to a fixed-amplitude signal. Using the representation given in Equation 19, this is:

$$\begin{matrix}S2 lim = cos ( ( {ω}_{1} \pm δω ) t + Φ ( t ) + θ ( t ) ) \\ = cos ( Θ ( t ) )\end{matrix} \qquad ( 22 )$$

whereby it will be seen that the random amplitude fluctuation component ρ(t) has been removed. When the signals represented by Equation 21, i.e., the output of IF filter 210, and by Equation 22, i.e., the output of amplitude limiter (hard limiter) 209, are input to frequency converter 211 and their sum frequency component extracted, the signal obtained is:

$$\begin{matrix}S2c ( t ) = ρ ( t ) [ cos ( {ω}_{2} t ) + \{ ( {L}_{+} + {R}_{+} ) cos ( {ω}_{2} t ) + H ( ( {L}_{+} + {R}_{+} ) ) sin ( {ω}_{2} t ) \} / 2 + \{ ( {L}_{-} + {R}_{-} ) cos ( {ω}_{2} t ) - H ( ( {L}_{-} + {R}_{-} ) ) sin ( {ω}_{2} t ) \} / 2 ] & ( 23 ) \\ = ρ ( t ) ( 1 + L + R ) cos ( {ω}_{2} t ) & ( 24 )\end{matrix}$$

In other words, the frequency fluctuation ±δω of local oscillator 205, the modulation component Φ(t), and the random disturbance component θ(t) that were present in the phase term can be completely removed. At the same time, the angular frequency of the carrier is converted to ω₂. Consequently, frequency stability in the subsequent demodulation processing is dependent only on local oscillator 208. As a result, if angular frequency ω₂ is low, frequency stability ceases to be a practical problem and a sharp filter can be used in the subsequent signal processing.

The use of IF filter 212 serves to extract, from the signal output by frequency converter 211 and expressed by Equation 23—this being a signal from which some unwanted noise components have been removed and to which a carrier component has been added—only the lower sideband signal. Omitting remaining noise components from the mathematical expression, this extracted signal can be derived from Equation 23 and represented by:

S2d(t)=ρ(t){(1+(L₊+R₊)/2) cos (ω₂t)+(H((L₊+R₊)/2)) sin (ω₂t)} (25)

As previously mentioned, the extracted lower sideband signal that can be described by Equation 25 corresponds to the upper sideband of the transmitted wave. Because this extracted lower sideband signal has a carrier component which is 6 dB higher than the maximum value of the information signal, it can be used as an RZ SSB signal. The use of RZ SSB demodulation processor 213 enables the random amplitude component ρ(t) to be removed and thereby provides a high-quality demodulated sum information signal (L+R).

When the angle component is extracted by frequency discriminator 215 from the other split portion of the output of amplitude limiter (hard limiter) 209, the resulting signal is:

$$\begin{matrix}S2e ( t ) = ⅆ / ⅆ t ( Θ ( t ) ) \\ = ( {ω}_{1} \pm δω ) + ⅆ / ⅆ t ( Φ ( t ) + θ ( t ) )\end{matrix} \qquad ( 26 )$$

When the DC component and the random FM noise component contained in this signal are removed by band-pass filter 216, the resulting signal is:

S2f(t)=d/dt(Φ(t)) (27)

When this output of band-pass filter 216 is integrated by integrator 217, the signal obtained is given by:

S2g(t)=Φ(t) (28)

thereby providing an angle signal Φ(t) which contains the modulation component relating to the sum and difference signals. Tangent function generator 218 operates on this angle signal to form:

S2h(t)=tan Φ(t) (29)

Delay circuit 214 is inserted to ensure that the processing delay up to and including RZ SSB demodulation processor 213 matches the processing delay from frequency discriminator 215 up to and including tangent function generator 218. The output of delay circuit 214 is added by adder 220 to the output of constant generator 219, whereby the following signal is obtained:

S2i(t)=1+L+R (30)

When the output of adder 220, expressed by Equation 30, is multiplied in multiplier 221 by the output of tangent function generator 218, expressed by Equation 29, the difference signal (L−R+P) is obtained:

$$\begin{matrix}S2j ( t ) = ( 1 + L + R ) tan Φ ( t ) \\ = L - R + P\end{matrix} \qquad ( 31 )$$

The relation shown in Equation 2 is used to derive this. The output of multiplier 221 is split into two portions, one of which is supplied to band-pass filter 222 and the other to low-pass filter 223. The difference signal (L−R) from which unwanted noise components have been removed by band-pass filter 222, and the sum signal (L+R) obtained from delay circuit 214, are supplied to matrix circuit 224, whereupon the left signal is output from left audio signal output terminal 225 and the right signal is output from right audio signal output terminal 226. The pilot signal P is obtained from the output of low-pass filter 223, and is output from pilot signal output terminal 227.

The signal processing after IF filter 206 can be performed by a DSP circuit. As explained above, when the lower sideband signal with added carrier component is extracted, frequency stability is determined solely by local oscillator 208, and therefore this extraction can be performed using IF filter 212 having sharp cut-off characteristics. Other advantages of a filter implemented by a DSP circuit include the fact that temperature characteristics, etc., do not have to be taken into consideration. If the embodiment shown in FIG. 2 is implemented using a DSP device, in order to make the frequency region in which unnecessary processing is performed as small as possible and so reduce the DSP power consumption, it is necessary to lower the sampling frequency of the RZ SSB demodulation processor. This can be achieved by shifting the signal frequency region to as low a frequency region as possible.

Third Embodiment

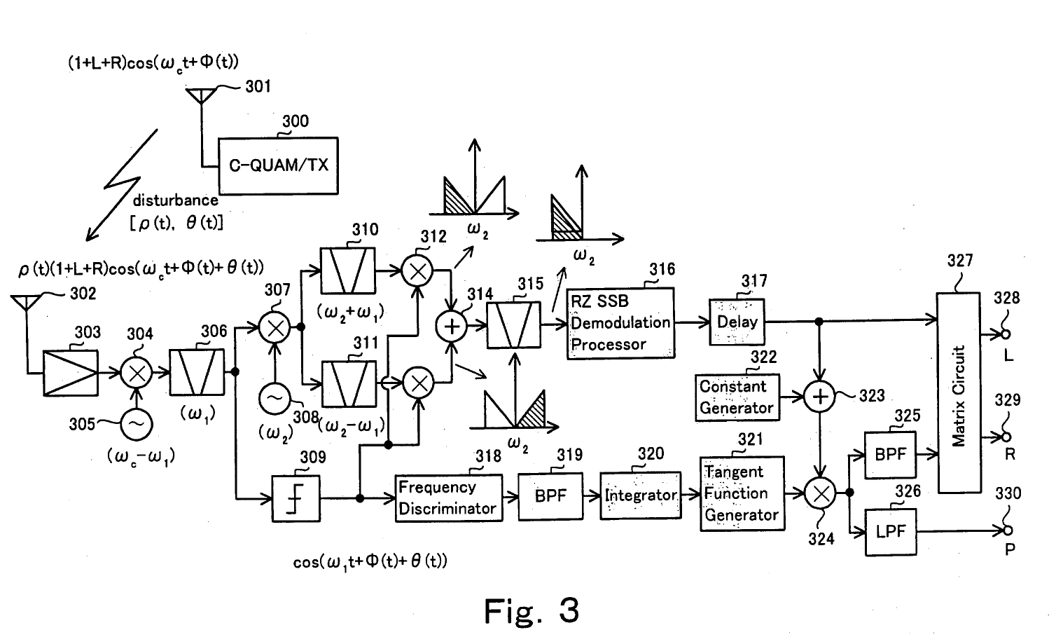

A third specific embodiment of the present invention will now be described. FIG. 3 is a block diagram showing the configuration of this third embodiment, which comprises C-Quam transmitter 300, transmitting antenna 301, receiving antenna 302 of a C-Quam receiver, front-end amplifier 303, frequency converter 304, local oscillator 305, IF filter 306, frequency converter 307, local oscillator 308, amplitude limiter (hard limiter) 309, IF filters 310 and 311, frequency converters 312 and 313, adder 314, IF filter 315, RZ SSB demodulation processor 316, delay circuit 317, frequency discriminator 318, band-pass filter 319, integrator 320, tangent function generator 321, constant generator 322, adder 323, multiplier 324, band-pass filter 325, low-pass filter 326, matrix circuit 327, left audio signal output terminal 328, right audio signal output terminal 329, and pilot signal output terminal 330.

A brief description will now be given of signal flow in this third embodiment shown in FIG. 3, and of the functioning of its component circuits.

The output of C-Quam transmitter 300 is transmitted, as a C-Quam modulated wave by transmitting antenna 301.

The C-Quam modulated wave is received by antenna 302 of the C-Quam receiver, and after it has been amplified by front-end amplifier 303, is converted by frequency converter 304 and local oscillator 305 to the difference frequency signal, whereupon the required IF signal is extracted, by IF filter 306.

The extracted signal is split into two portions and one portion supplied to frequency converter 307. The sum and difference frequencies between this signal and the signal from local oscillator 308 are formed. The sum frequency is extracted by IF filter 310 and the difference frequency is extracted by IF filter 311. The other split portion of the signal is supplied to amplitude limiter (hard limiter) 309 where it is converted to a fixed-amplitude signal. The output of amplitude limiter (hard limiter) 309 is split into two portions, and one portion is again split into two portions. Frequency converter 312 uses one of the split output portions from amplitude limiter 309 to form the difference frequency component between this signal and the output signal of IF filter 310. Likewise, frequency converter 313 uses one of the split output portions from amplitude limiter 309 to form the sum frequency component between this signal and the output signal of IF filter 311. The outputs of frequency converter 312 and frequency converter 313 are added by adder 314, whereupon IF filter 315 extracts the lower sideband component, this being a signal from which some unwanted noise components have been removed and which is accompanied by a carrier component. The output of IF filter 315 is supplied to RZ SSB demodulation processor 316 which demodulates it, thereby obtaining the sum signal (L+R). This sum signal is supplied to delay circuit 317.

The other split portion of the output of amplitude limiter (hard limiter) 309 has its angle component extracted by frequency discriminator 318. The output of frequency discriminator 318 has its DC component and random FM noise component removed by band-pass filter 319. The output of band-pass filter 319 is integrated by integrator 320, after which tangent function generator 321 generates the tangent value corresponding to the input angle.

The output of delay circuit 317 is split into two portions, one of which is added by adder 323 to the output of constant generator 322. The output of adder 323 is multiplied, by multiplier 324, by the output of tangent function generator 321. The output of multiplier 324 is split into two portions, one of which is supplied to band-pass filter 325 and the other to low-pass filter 326. Band-pass filter 325 provides a signal from which unwanted noise components have been removed. This signal is supplied to matrix circuit 327. The other split portion of the output of delay circuit 317 is also supplied to matrix circuit 327, whereupon the left signal is output from left audio signal output terminal 328 and the right signal is output from right audio signal output terminal 329. The pilot signal P is obtained from the output of low-pass filter 326, and is output from pilot signal output terminal 330.

The operation of the component circuits will now be described using mathematical expressions. During its propagation, the signal radiated from transmitting antenna 301 is subject to random amplitude fluctuation and to phase fluctuation (random FM noise) which obey the Rayleigh distribution rule and can be represented respectively by ρ(t) and θ(t) in the amplitude and phase terms. These amplitude and phase fluctuations affect the signal as multiplicative disturbances. Hence the signal that arrives at C-Quam receiver antenna 302 is given by:

Sr3(t)=ρ(t)(1+L+R) cos (ω_{c}t+Φ(t)+θ(t)) (32)

The received signal is amplified by front-end amplifier 303 (which preferably changes its degree of amplification by means of a Received Signal Strength Indication mechanism). Then, by way of example, frequency converter 304 uses the signal from local oscillator 305, which has a center angular frequency of ω_{c}−ω₁ and an angular frequency fluctuation of ±δω, to convert the received signal to the difference frequency, whereby it is converted to an IF signal with a center angular frequency of ω₁. IF filter 306 extracts just the required IF signal component. If thermal noise added by front-end amplifier 303 is ignored, the extracted signal is easily derived from Equation 32:

S3a(t)=ρ(t)(1+L+R) cos ((ω₁±δω)t+Φ(t)+θ(t)) (33)

which can be rewritten as:

$$S3a ( t ) = ρ ( t ) [ cos Θ ( t ) + \{ ( {L}_{+} + {R}_{+} ) cos ( Θ ( t ) ) - H ( ( {L}_{+} + {R}_{+} ) ) sin ( Θ ( t ) ) \} / 2 + \{ ( {L}_{-} + {R}_{-} ) cos ( Θ ( t ) ) + H ( ( {L}_{-} + {R}_{-} ) ) sin ( Θ ( t ) ) \} / 2 ] \qquad ( 34 )$$

where:

Θ(t)=(ω₁±δω)t+Φ(t)+θ(t)

(L₊+R₊)=(L₋+R₋)

H((L₊+R₊))=H((L₋+R₋))

and (L₊+R₊) and (L₋+R₋) represent, respectively, the information signal present in the upper sideband region and in the lower sideband region of the transmitted wave, and H((L₊+R₊)) represents the Hilbert transformation of (L₊+R₊). The first, second and third terms in Equation 34 are the mathematical representations of the carrier component, the upper sideband component, and the lower sideband component, respectively. At this stage in the signal processing, the mutual arrangement of the upper and lower sideband components is the same as in the transmitted wave. From Equation 34 it will be seen that in an AM signal that is not overmodulated—i.e., in an AM signal that satisfies the condition expressed by Equation 3—the carrier component is always 6 dB higher than the sideband components. In FIG. 3, the signals are depicted in such manner that the upper sideband component and the lower sideband component can be distinguished. Although Equation 33 and Equation 34 are mathematically equivalent, when we are considering single sideband components we will use Equation 34 whenever it is necessary to discuss extracting a specific single sideband component, i.e., specifically either the upper sideband component or the lower sideband component.

The signal expressed by Equation 33 or Equation 34, and which is the output of IF filter 306, is split into two portions. One portion of the split signal is supplied to frequency converter 307, which uses local oscillator 308 with angular frequency ω₂ to form the sum frequency, thereby converting the signal from IF filter 306 to an IF signal with a center angular frequency of ω₁+ω₂. IF filter 310 then extracts only this required IF signal component. Using Equation 34, this extracted signal can be given as:

$$S3b ( t ) = ρ ( t ) [ cos ( Θ ( t ) + {ω}_{2} t ) + \{ ( {L}_{+} + {R}_{+} ) cos ( Θ ( t ) + {ω}_{2} t ) - H ( ( {L}_{+} + {R}_{+} ) ) sin ( Θ ( t ) + {ω}_{2} t ) \} / 2 + \{ ( {L}_{-} + {R}_{-} ) cos ( Θ ( t ) + {ω}_{2} t ) + H ( ( {L}_{-} + {R}_{-} ) ) sin ( Θ ( t ) + {ω}_{2} t ) \} / 2 ] \qquad ( 35 )$$

Frequency converter 307 also uses local oscillator 308 with angular frequency ω₂ to form the difference frequency, thereby converting the signal from IF filter 306 to an IF signal with a center angular frequency of ω₂−ω₁. IF filter 311 then extracts only this required IF signal component. This signal is:

$$S3c ( t ) = ρ ( t ) [ cos ( {ω}_{2} t - Θ ( t ) ) + ( {L}_{+} + {R}_{+} ) cos ( {ω}_{2} t - Θ ( t ) ) - H ( ( {L}_{+} + {R}_{+} ) ) sin ( {ω}_{2} t - Θ ( t ) ) \} / 2 + \{ ( {L}_{-} + {R}_{-} ) cos ( {ω}_{2} t - Θ ( t ) ) + H ( ( {L}_{-} + {R}_{-} ) ) sin ( {ω}_{2} t - Θ ( t ) ) \} / 2 \qquad ( 36 )$$

In this embodiment, the frequency relation ω₂>ω₁ is used, and hence the positions of the top and bottom sideband components of the transmitted wave are reversed in the output of IF filter 311.

The other portion of the split signal from IF filter 306 is supplied to amplitude limiter (hard limiter) 309 where it is converted to a fixed-amplitude signal, given by:

$$\begin{matrix}S3 lim = cos ( ( {ω}_{1} \pm δω ) t + Φ ( t ) + θ ( t ) ) \\ = cos ( Θ ( t ) )\end{matrix} \qquad ( 37 )$$

whereby it will be seen that the random amplitude fluctuation component ρ(t) has been removed.

When the signals represented by Equation 35, i.e., the output of IF filter 310, and by Equation 37, i.e., the output of amplitude limiter (hard limiter) 309, are input to frequency converter 312 and their difference frequency component extracted, the signal obtained is:

$$S3d ( t ) = ρ ( t ) [ cos ( {ω}_{2} t ) + \{ ( {L}_{+} + {R}_{+} ) cos ( {ω}_{2} t ) - H ( ( {L}_{+} + {R}_{+} ) ) sin ( {ω}_{2} t ) \} / 2 + \{ ( {L}_{-} + {R}_{-} ) cos ( {ω}_{2} t ) + H ( ( {L}_{-} + {R}_{-} ) ) sin ( {ω}_{2} t ) \} / 2 ] \qquad ( 38 )$$

Likewise, when the signals represented by Equation 36, i.e., the output of IF filter 311, and by Equation 37, i.e., the output of amplitude limiter (hard limiter) 309, are input to frequency converter 313 and their sum frequency component extracted, the signal obtained is:

$$S3e ( t ) = ρ ( t ) [ cos ( {ω}_{2} t ) + \{ ( {L}_{+} + {R}_{+} ) cos ( {ω}_{2} t ) + H ( ( {L}_{+} + {R}_{+} ) ) sin ( {ω}_{2} t ) \} / 2 + \{ ( {L}_{-} + {R}_{-} ) cos ( {ω}_{2} t ) - H ( ( {L}_{-} + {R}_{-} ) ) sin ( {ω}_{2} t ) \} / 2 ] \qquad ( 39 )$$

Equations 38 and 39 indicate that the frequency fluctuation ±δω of local oscillator 305, the modulation component Φ(t), and the random disturbance component θ(t) that were present in the phase term can be completely removed. At the same time, the angular frequency of the carrier is converted to ω₂. Consequently, frequency stability in the subsequent demodulation processing is dependent only on local oscillator 308. As a result, if angular frequency ω₂ is low, frequency stability ceases to be a practical problem and a sharp filter can be used in the subsequent signal processing.

The outputs of frequency converters 312 and 313, which can be described by Equations 38 and 39, are added by adder 314, whereupon use of IF filter 315 serves to extract only the lower sideband signal, which is a signal from which some unwanted noise components have been removed and to which a carrier component has been added. Omitting remaining noise components from the mathematical expression, this extracted signal can be represented by:

$$S3f ( t ) = ρ ( t ) [ 2 cos ( {ω}_{2} t ) + \{ ( {L}_{+} + {R}_{+} ) cos ( {ω}_{2} t ) + H ( ( {L}_{+} + {R}_{+} ) ) sin ( {ω}_{2} t ) \} / 2 + \{ ( {L}_{-} + {R}_{-} ) cos ( {ω}_{2} t ) + H ( ( {L}_{-} + {R}_{-} ) ) sin ( {ω}_{2} t ) \} / 2 ] \qquad ( 40 )$$

Because the second and third terms of Equation 40 were originally the upper and lower sidebands, respectively, when the transmitted wave propagated through the propagation path, a diversity effect can be anticipated, since the upper and lower sidebands can be expected to experience different degrees of deterioration during propagation. As mentioned in the description of the first embodiment, it is evident that the lower sideband signal given by Equation 40 can be used as an RZ SSB signal. Accordingly, the use of an RZ SSB demodulation processor enables the disturbance component ρ(t) to be removed, which, coupled with the diversity effect, enables a high-quality demodulated sum signal (L+R) to be obtained.

When the angle component is extracted by frequency discriminator 318 from the other split portion of the output of amplitude limiter (hard limiter) 309, the resulting signal is:

$$\begin{matrix}S3g ( t ) = ⅆ / ⅆ t ( Θ ( t ) ) \\ = ( {ω}_{1} \pm δω ) + ⅆ / ⅆ t ( Φ ( t ) + θ ( t ) )\end{matrix} \qquad ( 41 )$$

When the DC component and the random FM noise component contained in this signal are removed by band-pass filter 319, the resulting signal is:

S3h(t)=d/dt(Φ(t)) (42)

When this output of band-pass filter 319 is integrated by integrator 320, the signal obtained is given by:

S3i(t)=Φ(t) (43)

thereby providing an angle signal Φ(t) which contains the modulation component relating to the sum and difference signals. Tangent function generator 321 operates on this angle signal to form:

S3j(t)=tan Φ(t) (44)

Delay circuit 317 is inserted to ensure that the processing delay up to and including RZ SSB demodulation processor 316 matches the processing delay from frequency discriminator 318 up to and including tangent function generator 321. The output of delay circuit 317 is added by adder 323 to the output of constant generator 322, whereby the following signal is obtained:

S3k(t)=1+L+R (45)

When the output of adder 323, expressed by Equation 45, is multiplied in multiplier 324 by the output of tangent function generator 321, expressed by Equation 44, the difference signal (L−R+P) is obtained:

$$\begin{matrix}S3l ( t ) = ( 1 + L + R ) tan Φ ( t ) \\ = L - R + P\end{matrix} \qquad ( 46 )$$

The relation shown in Equation 2 is used to derive this. The output of multiplier 324 is split into two portions, one of which is supplied to band-pass filter 325 and the other to low-pass filter 326. The difference signal (L−R) from which unwanted noise components have been removed by band-pass filter 325, and the sum signal (L+R) obtained from delay circuit 317, are supplied to matrix circuit 327, whereupon the left signal is output from left audio signal output terminal 328 and the right signal is output from right audio signal output terminal 329. The pilot signal P is obtained from the output of low-pass filter 326, and is output from pilot signal output terminal 330.

The signal processing after IF filter 306 can be performed by a DSP circuit. As explained above, when the lower sideband signal with added carrier component is extracted, frequency stability is determined solely by local oscillator 308, and therefore this extraction can be performed using IF filter 315 having sharp cut-off characteristics. Other advantages of a filter implemented by a DSP circuit include the fact that temperature characteristics, etc., do not have to be taken into consideration. If the embodiment shown in FIG. 3 is implemented using a DSP device, in order to make the frequency region in which unnecessary processing is performed as small as possible and so reduce the DSP power consumption, it is necessary to lower the sampling frequency of the RZ SSB demodulation processor. This can be achieved by shifting the signal frequency region to as low a frequency region as possible.

As has been described above, the present invention provides the following benefits:

1. A demodulated signal with frequency characteristics that are faithful to the frequency characteristics of the transmitted wave is obtained, and the quality of the demodulated signal is better than that obtained with a conventional receiving circuit.

2. Reception characteristics are resistant to external multiplicative noise resulting from fading and so forth, and hence the quality of the demodulated signal is improved.

3. The invention provides a receiving circuit configuration which, while maintaining the advantages of a conventional AM receiver, can demodulate a C-Quam modulated signal without being strongly affected by frequency fluctuations. The receiver of the invention therefore has an inexpensive configuration.

4. An improvement in demodulation quality is achieved by configuring the receiving circuit so that, by using both the upper sideband and the lower sideband obtained by processing a C-Quam modulated signal, a frequency diversity effect is obtained.

What is claimed is:

1. A medium-frequency stereo broadcast receiving circuit for receiving and demodulating a medium-frequency stereo broadcast wave comprising an angle-modulated wave that has been modulated by the sum signal and by the difference signal of left and right information signals, said angle-modulated wave also having been amplitude-modulated by said sum signal; said medium-frequency stereo broadcast receiving circuit comprising:
sum signal demodulation means for converting the received medium-frequency stereo broadcast wave to a single-sideband signal, and for demodulating the sum signal from the phase term of this converted single-sideband signal; and
difference signal demodulation means for demodulating the difference signal from the phase term of the received medium-frequency stereo broadcast wave and the demodulated output of said sum signal demodulation means.

2. The medium-frequency stereo broadcast receiving circuit of claim 1, wherein said sum signal demodulation means comprises:
first frequency conversion means for frequency converting the received medium-frequency stereo broadcast wave;
means for branching the input signal to this first frequency conversion means and for limiting the amplitude of the branched portion of the signal;
second frequency conversion means for removing unwanted modulated signal components when demodulating the sum signal, by multiplying together the output of said amplitude limiting means and the output of said first frequency conversion means; and
means for converting the amplitude-modulated wave that is output by this second frequency conversion means to a single-sideband signal.

3. The medium-frequency stereo broadcast receiving circuit of claim 2, wherein said first frequency conversion means is provided in an intermediate frequency stage.

4. The medium-frequency stereo broadcast receiving circuit of claim 1, wherein the medium-frequency stereo broadcast wave is a signal that can be expressed as a function of time (t) by:
S(t)=(1+L+R) cos (ω_{c}t+Φ(t))
where
tan Φ(t)=(L−R+P)/(1+L+R)
and ω_{c} is the angular frequency of the carrier, (L+R) is the sum signal, (L−R) is the difference signal, and P is a pilot signal superimposed on the difference signal; and
said difference signal demodulation means comprises:
a frequency discriminator for discriminating the frequency of the received medium-frequency stereo broadcast wave and extracting the angle component d/dt(Φ(t));
an integrator for integrating the extracted angle component d/dt(Φ(t));
a tangent function generator for generating the tangent function value tan Φ(t) of the output Φ(t) of the integrator; and
means for multiplying together the output of this tangent function generator and the signal obtained by equalizing the delay of the output of said sum signal demodulation means and adding a suitable constant.

5. The medium-frequency stereo broadcast receiving circuit of claim 2, wherein the medium-frequency stereo broadcast wave is a signal that can be expressed as a function of time (t) by:
S(t)=(1+L+R) cos (ω_{c}t+Φ(t))
where
tan Φ(t)=(L−R+P)/(1+L+R)
and ω_{c} is the angular frequency of the carrier, (L+R) is the sum signal, (L−R) is the difference signal, and P is a pilot signal superimposed on the difference signal; and
said difference signal demodulation means comprises:
a frequency discriminator for discriminating the frequency of the output of said amplitude limiting means and extracting the angle component d/dt(Φ(t));
an integrator for integrating the extracted angle component d/dt(Φ(t));
a tangent function generator for generating the tangent function value tan Φ(t) of the output Φ(t) of the integrator; and
means for multiplying together the output of this tangent function generator and the signal obtained by equalizing the delay of the output of said sum signal demodulation means and adding a suitable constant.

6. The medium-frequency stereo broadcast receiving circuit of claim 1, wherein said sum signal demodulation means comprises frequency diversity means for superimposing the received medium-frequency stereo broadcast wave and the signal obtained by reversing, in the frequency domain, the distribution of frequency components of this wave, and for converting the resulting superimposed signal into one single-sideband signal.

7. The medium-frequency stereo broadcast receiving circuit of claim 6, wherein said frequency diversity means is provided in an intermediate frequency stage and comprises:
first frequency conversion means for multiplying together the medium-frequency stereo broadcast wave that has been converted to an intermediate frequency, and a local oscillator signal with a higher frequency than the carrier component of the converted stereo broadcast wave, and for extracting the difference frequency component and the sum frequency component, which have mutually reversed distributions, in the frequency domain, of signal frequency components;
means for branching the input signal to said first frequency conversion means and for limiting the amplitude of the branched portion of the signal;
second frequency conversion means for (i) multiplying together the output of said amplitude limiting means and the difference frequency component extracted by said first frequency conversion means, and for extracting the sum frequency component, and for (ii) multiplying together the output of said amplitude limiting means and the sum frequency component extracted by said first frequency conversion means, and for extracting the difference frequency component; and
means for adding the sum frequency component and the difference frequency component obtained by said second frequency conversion means.
